(19) United States
(12) Patent Application Publication
(10) Pub. No.: US 2015/0020852 A1
(43) Pub. Date: Jan. 22, 2015

(54) SUBSTRATE PROCESSING APPARATUS AND SUBSTRATE PROCESSING METHOD

(71) Applicant: DAINIPPON SCREEN MFG. CO., LTD., Kyoto (JP)

(72) Inventors: Masahiko KATO, Kyoto (JP); Katsuhiko MIYA, Kyoto (JP); Hiroyuki YASHIKI, Kyoto (JP); Yoshiki IMURO, Kyoto (JP)

(21) Appl. No.: 14/332,909

(22) Filed: Jul. 16, 2014

(30) Foreign Application Priority Data
Jul. 16, 2013 (JP) 2013-147435

(51) Int. Cl. B08B 3/10

(52) U.S. Cl. CPC B08B 3/10
USPC 134/30; 134/105

(57) ABSTRACT

A substrate processing apparatus comprises: an air flow generator which generates a down flow by gas flowing from top to bottom around a substrate W held horizontally; a liquid film former which forms a liquid film by supplying a liquid on an upper surface of the substrate; a cooling gas discharge nozzle which discharges cooling gas of a temperature lower than a freezing point of the liquid to the liquid film and thereby freezes the liquid film; and a remover which removes a frozen film formed by freezing the liquid film from the substrate. The air flow generator reduces a flow velocity of the down flow when the cooling gas is discharged to the liquid film from the cooling gas discharge nozzle than when the liquid is supplied to the substrate from the liquid film former.

### CROSS REFERENCE TO RELATED APPLICATION

The disclosure of Japanese Patent Application No. 2013-147435 filed on Jul. 16, 2013 including specification, drawings and claims is incorporated herein by reference in its entirety.

### BACKGROUND OF THE INVENTION

1. Field of the Invention

This invention relates to a substrate processing apparatus and a substrate processing method for processing a substrate by forming a liquid film on a substrate, freezing the liquid film and thawing a frozen film.

2. Description of the Related Art

A freeze cleaning technology has been and is being studied as a cleaning technology for removing extraneous matters such as particles adhering to a substrate. This technology is for separating extraneous matters utilizing a volumetric change when a liquid is frozen by forming a liquid film on a surface of a substrate as an object to be processed, freezing the liquid film and thawing a frozen film.

For example, in a technology described in JP2012-169588A, a liquid in a supercooling state is supplied to an upper surface of a substrate held in a horizontal posture in a processing space surrounded by a wall surface, and a frozen film is formed by freezing the liquid by an impact when the liquid lands on the substrate. Further, in this technology, a fan filter unit is provided above the processing space to form a down flow by clean air in the processing space, thereby preventing mist and the like inevitably generated in an ambient atmosphere during the process from falling down on the substrate.

Further, a method for freezing a liquid film formed on a substrate by locally discharging cooling gas of a temperature lower than a freezing point of a liquid forming the liquid film to the liquid film from a nozzle, for example, as described in JP2012-204559A is known as another method for forming a frozen film on a substrate. Also in such a technology, it is desired to execute an atmosphere control as in the above technology.

However, an experiment by the inventors of this application revealed that a sufficient effect of removing extraneous matters could not be obtained in the case of performing the down flow generation and the freezing method described in the above literatures in combination. One of the causes is thought to be a reduction in ability to cool a liquid film due to a gas temperature rise caused by the scattering of cooling gas discharged to the liquid film by a down flow and the mixture of an ambient atmosphere with the cooling gas.

### SUMMARY OF THE INVENTION

This invention was developed in view of the above problems and aims to provide a technology capable of achieving good removal efficiency while properly controlling an atmosphere around a substrate in a substrate processing apparatus and a substrate processing method for processing a substrate by freezing a liquid film formed on a substrate and removing a frozen film.

An aspect of a substrate processing apparatus according to the present invention comprises: a substrate holder which holds a substrate in a horizontal posture; an air flow generator which generates a down flow by gas flowing from top to bottom around the substrate held by the substrate holder; a liquid film former which forms a liquid film by supplying a liquid on an upper surface of the substrate held by the substrate holder; a cooling gas discharge nozzle which discharges cooling gas of a temperature lower than a freezing point of the liquid forming the liquid film to the liquid film and thereby freezes the liquid film; and a remover which removes a frozen film formed by freezing the liquid film from the substrate, wherein the air flow generator reduces a flow velocity of the down flow when the cooling gas is discharged to the liquid film from the cooling gas discharge nozzle than when the liquid is supplied to the substrate from the liquid film former.

An aspect of a substrate processing method according to the present invention comprises: a substrate holding step of holding a substrate in a horizontal posture; an air flow generating step of generating a down flow by gas flowing from top to bottom around the substrate; a liquid film forming step of forming a liquid film by supplying a liquid on an upper surface of the substrate; a freezing step of freezing the liquid film by supplying cooling gas of a temperature lower than a freezing point of the liquid forming the liquid film to the liquid film; and a removing step of removing a frozen film formed by freezing the liquid film from the substrate, wherein a flow velocity of the down flow in the freezing step is set lower than a flow velocity of the down flow in the liquid film forming step.

In the invention thus configured, a down flow having a relatively high flow velocity is formed when the liquid is supplied to the substrate to form the liquid film. This can push out liquid droplets, mist and the like scattering around the substrate downward to prevent adhesion to the substrate. On the other hand, when the cooling gas is supplied to freeze the liquid film, the flow velocity of the down flow is reduced. This causes the cooling gas supplied to the liquid film on the substrate to stay long on the substrate without being scattered, whereby the liquid film can be efficiently cooled and frozen. According to the knowledge of the inventors of this application, a removal rate for extraneous matters is found to be improved with a decrease in the temperature of the frozen film. Since the frozen film of a sufficiently low temperature can be formed even within a short time, the removal rate for extraneous matters can be improved.

Mist and the like are thought to easily fall down on the substrate by weakening the down flow. However, since the generation of mist and the like is considerably less likely to occur than during a supply period of the liquid and, in addition, the substrate upper surface is covered by the liquid film and the liquid film is further covered by the cooling gas being supplied, the substrate surface is blocked from the mist and the like in an ambient atmosphere and a possibility of adhesion of mist and the like to the substrate is very low. In this sense, the generation of the down flow by other means may be completely stopped during the supply of the cooling gas to the liquid film. This is because the flow of the cooling gas itself functions as the down flow.

Another aspect of a substrate processing apparatus according to the present invention comprises: a substrate holder which holds a substrate in a horizontal posture; a liquid film former which forms a liquid film by supplying a liquid on an upper surface of the substrate held by the substrate holder; a cooling gas discharge nozzle which discharges cooling gas of a temperature lower than a freezing point of the liquid forming the liquid film to the liquid film and thereby freezes the liquid film; a remover which removes a frozen film formed by freezing the liquid film from the substrate; a collector which includes a side wall for laterally surrounding the substrate held by the substrate holder and is configured such that the substrate is housed in an internal space enclosed by the side wall, an opening for exposing an upper part of the substrate is formed by an upper end part of the side wall and the liquid falling down from the substrate is collected; and a drainer which drains a fluid in the internal space of the collector to outside, wherein the drainer reduces a drain amount of the fluid from the internal space when the cooling gas is discharged to the liquid film from the cooling gas discharge nozzle than when the liquid is supplied to the substrate from the liquid film former.

Also in the case of processing the substrate in the internal space of such a collector, the outside atmosphere flows into the internal space through the opening in the upper part of the collector to generate an air flow due the exhaust of the fluid in the internal space, specifically, the gas or a mixture of the gas and liquid in the internal space. This causes a down flow to be generated around the substrate. Thus, a problem of reducing removal efficiency due to the scattering of the cooling gas described above may similarly occur. By reducing the exhaust amount of the fluid from the internal space when the cooling gas is supplied to the liquid film, it is possible to weaken the down flow around the substrate and prevent the scattering of the cooling gas. Therefore, it is possible to form the frozen film cooled to a sufficiently low temperature and improve efficiency in removing extraneous matters.

According to this invention, since a down flow having a relatively high flow velocity is generated around the substrate when the liquid is supplied to the substrate to form the liquid film, the adhesion of mist and the like generated in the ambient atmosphere to the substrate is prevented. On the other hand, by weakening the down flow when the cooling gas is supplied to the liquid film, the liquid film can be cooled in a short time by suppressing the scattering of the cooling gas. As just described, in the invention, it is possible to achieve good efficiency in removing extraneous matters while properly controlling the atmosphere around the substrate.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a side view diagrammatically showing one embodiment of a substrate processing apparatus according to the invention.

FIG. 2 is a plan view showing the arrangement and moving modes of nozzles.

FIG. 3 is a flow chart showing an example of the substrate cleaning process.

FIGS. 4A to 4C, 5A and 5B are views diagrammatically showing the operation of each component in the substrate cleaning process.

FIGS. 6A to 6C are views diagrammatically showing the atmosphere control in this embodiment.

FIG. 7 is a graph showing an example of an experimental result of measurement of the particle removal rate by changing the intensity of the down flow near the substrate surface.

### DETAILED DESCRIPTION OF THE PREFERRED EMBODIMENTS

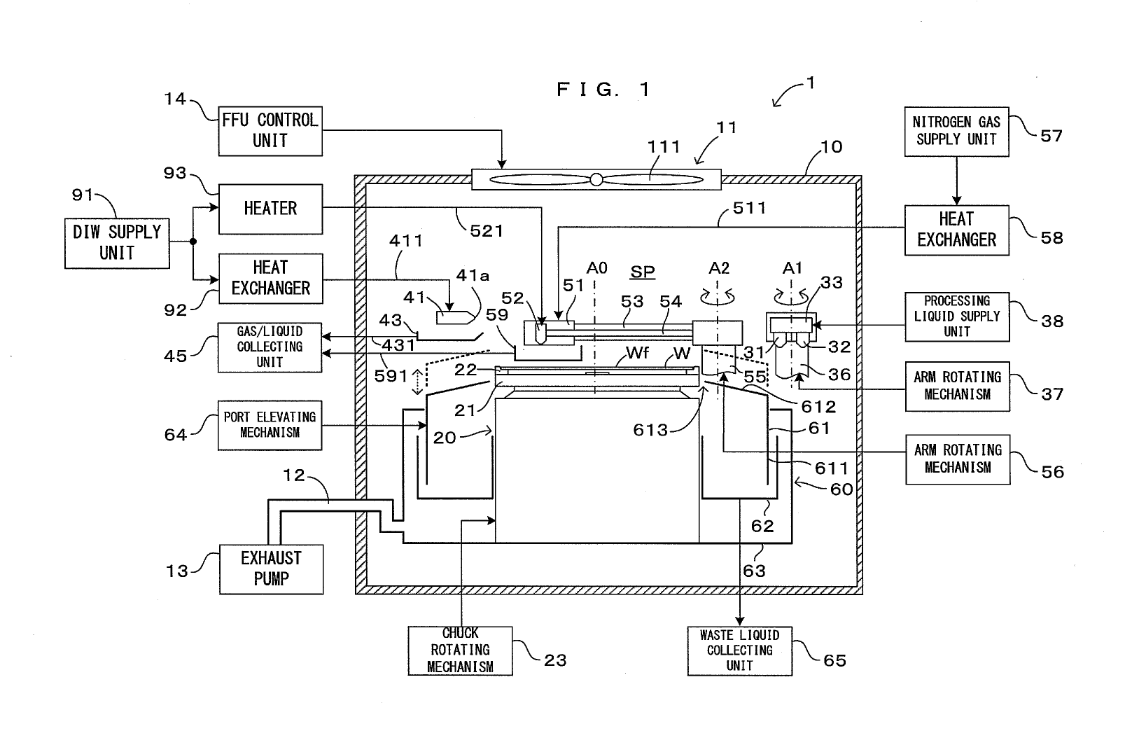

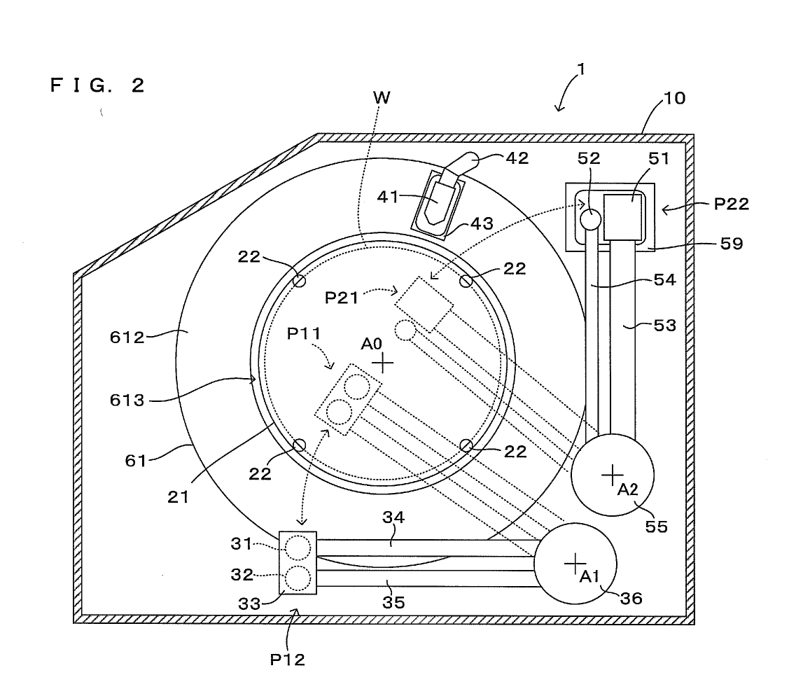

FIG. 1 is a side view diagrammatically showing one embodiment of a substrate processing apparatus according to the invention. FIG. 2 is a plan view showing the arrangement and moving modes of nozzles. This substrate processing apparatus 1 functions as a single-wafer substrate cleaning apparatus capable of performing a substrate cleaning process to remove extraneous matters such as particles adhering to a surface (pattern forming surface) Wf of a substrate W such as a semiconductor wafer. More specifically, this substrate processing apparatus 1 performs a freeze cleaning process of removing extraneous matters adhering to the substrate W together with a frozen film by removing the frozen film after forming a liquid film on the surface Wf of the substrate W and freezing the liquid film as the substrate cleaning process.

The substrate processing apparatus 1 includes a processing chamber 10 internally provided with a processing space SP in which a cleaning process is applied to the substrate W. A spin chuck 20 for rotating the substrate W while holding the substrate W substantially horizontally with the substrate surface Wf faced up is arranged in the processing chamber 10. A series of substrate processes to be described later are performed on the substrate W held by the spin chuck 20.

An FFU (fan filter unit) 11 for supplying clean gas to the processing space SP in the processing chamber 10 is provided in a central part of the upper surface of the processing chamber 10. The FFU 11 takes in the outside atmosphere of the processing chamber 10 by a fan 111, collects and cleans fine particles and the like in the atmosphere by a built-in filter (not shown) and supplies clean air into the processing space SP. Accordingly, the processing space SP is kept in a clean atmosphere and an air flow (down flow) from an upper side toward a lower side is generated in the processing space SP. Since this causes airborne droplet, mist and the like of a liquid generated during the substrate cleaning process to be swept away to the lower side of the processing space SP, the adhesion thereof to the substrate W is suppressed. The operation of the FFU 11 is controlled by an FFU control unit 14. For example, the FFU control unit 14 can change a flow rate and a flow velocity of gas supplied to the processing space SP via the FFU 11 by controlling a rotation speed of the fan 111.

The spin chuck 20 arranged in the processing space SP includes a disc-shaped spin base 21 in an upper end part. The spin base 21 has a diameter equal to or slightly larger than that of the substrate W, and a plurality of chuck pins 22 for gripping a peripheral edge part of the substrate W are provided in a peripheral edge part. Each chuck pin 22 includes a supporting part for supporting the peripheral edge part of the substrate W from below and a holding part for holding the substrate W by coming into contact with an outer peripheral end surface of the substrate W supported by the supporting part. Each chuck pin 22 supports the substrate W from below and holds the substrate W from a lateral side, whereby the substrate W is held substantially in a horizontal posture while being spaced apart from the upper surface of the spin base 21. A chuck rotating mechanism 23 can rotate the spin base 21 and change a rotation speed of the spin base 21. The chuck rotating mechanism 23 rotates the spin base 21 at a suitable rotation speed, whereby the substrate W can be rotated at a desired rotation speed about a center of rotation A0.

A plurality of types of nozzles for performing each process to be described later on the substrate W held by the spin chuck 20, i.e. a chemical discharge nozzle 31 for discharging chemical such as hydrofluoric acid, a rinsing liquid discharge nozzle 32 for discharging a rinsing liquid such as DIW (deionized water), a low-temperature DIW discharge nozzle 41 for discharging low-temperature DIW, a cooling gas discharge nozzle 51 for discharging low-temperature nitrogen gas and a high-temperature DIW discharge nozzle 52 for discharging high-temperature DIW are provided in the processing chamber 10. A configuration relating to each nozzle is described in detail below. Note that although an arm for supporting each nozzle and a pipe for supplying a fluid to each nozzle are separately shown in the following description, a fluid may flow in a pipe provided in or integrally to an arm.

The chemical discharge nozzle 31 can perform a chemical process on the substrate W by discharging the chemical supplied from a processing liquid supply unit 38. Further, the rinsing liquid discharge nozzle 32 can perform a rinsing process on the substrate W by discharging the rinsing liquid supplied from the processing liquid supply unit 38.

The chemical discharge nozzle 31 and the rinsing liquid discharge nozzle 32 are integrally movable substantially in a horizontal direction. Specifically, the chemical discharge nozzle 31 and the rinsing liquid discharge nozzle 32 are respectively attached to tip parts of arms 34, 35 (FIG. 2) extending substantially in the horizontal direction via a common nozzle attaching portion 33. The arms 34, 35 are provided substantially in parallel and base end parts thereof are both connected to a rotary shaft 36 extending substantially in a vertical direction. An arm rotating mechanism 37 rotates the rotary shaft 36 about a center of rotation A1, whereby the chemical discharge nozzle 31 and the rinsing liquid discharge nozzle 32 are integrally movable between a facing position P11 facing the substrate W and a retracted position P12 above and laterally retracted from the upper surface of the substrate W as shown in FIG. 2. Then, the chemical is discharged downward from the chemical discharge nozzle 32 at the facing position P11 to perform the chemical process on the substrate surface Wf. Further, the rinsing liquid is discharged downward from the rinsing liquid discharge nozzle 32 at the facing position P11 to perform the rinsing liquid process on the substrate surface Wf. Note that the chemical discharge nozzle 31 and the rinsing liquid discharge nozzle 32 can be positioned at any arbitrary position facing the substrate W and the facing position P11 shown in FIG. 2 is an example thereof.

The DIW of a low temperature (hereinafter, referred to as “low-temperature DIW”) produced by cooling the DIW of a normal temperature and supplied from a DIW supply unit 91 by a heat exchanger 92 is supplied to the low-temperature DIW discharge nozzle 41 via a pipe 411. The low-temperature DIW discharged from the low-temperature DIW discharge nozzle 41 is supplied to the substrate surface Wf to form a liquid film made of the low-temperature DIW on the substrate surface Wf.

The low-temperature DIW discharge nozzle 41 is fixedly supported by a supporting member 42 (FIG. 2) at a position above and laterally deviated from the substrate W held by the spin chuck 20, more specifically at a position above an upper surface portion 612 of a port 61 of a splash guard 60 to be described later. The low-temperature DIW discharge nozzle 41 is fixed at such a position as not to cross movement paths of the movable chemical discharge nozzle 31 and rinsing liquid discharge nozzle 32 described above, the movable cooling gas discharge nozzle 51 and high-temperature DIW discharge nozzle 52 to be described later and arms 34, 35, 53 and 54 for supporting these nozzles.

The low-temperature DIW discharge nozzle 41 includes a discharge port 41a facing toward the center of rotation A0 of the substrate W. A receiving member 43 for receiving the low-temperature DIW falling from the discharge port 41a is provided below the low-temperature DIW discharge nozzle 41. More specifically, the receiving member 43 is in the form of a dish open upward, and the low-temperature DIW dropping from the discharge port 41a is received by the receiving member 43. Then, the low-temperature DIW received by the receiving member 43 is drained to the outside of the processing chamber 10 via a pipe 431 and collected by a gas/liquid collecting unit 45.

A discharge flow rate of the low-temperature DIW from the low-temperature DIW discharge nozzle 41 is changeable. If the low-temperature DIW discharged from the discharge port 41a flows at such a relatively high flow rate as to reach the substrate surface Wf (hereinafter, referred to as a “liquid film forming flow rate”), the low-temperature DIW is supplied substantially to a center of the substrate surface Wf and a liquid film forming process is performed in which a liquid film is formed by the low-temperature DIW on the substrate surface Wf. On the other hand, if the discharge flow rate of the low-temperature DIW is lower than the liquid film forming flow rate and all the low-temperature DIW discharged from the discharge port 41a falls to the receiving member 43 without reaching the substrate surface Wf (hereinafter, referred to as a “slow leak flow rate”), a slow leak process is performed in which the low-temperature DIW is discharged from the discharge port 41a in such a manner as not to be supplied to the substrate surface Wf. By performing the slow leak process before the liquid film forming process, a temperature rise due to the retention of the low-temperature DIW in the pipe 411 leading to the low-temperature DIW discharge nozzle 41 from the heat exchanger 92 and in the low-temperature DIW discharge nozzle 41 can be suppressed and the DIW of a sufficiently low temperature is supplied to the substrate surface Wf from an initial stage of the liquid film forming process. Note that a liquid temperature of the low-temperature DIW is preferably slightly higher than a freezing point of the DIW to enable the liquid film to be frozen in a short time.

The cooling gas discharge nozzle 51 discharges low-temperature nitrogen gas (hereinafter, referred to as “cooling gas”) produced by cooling the nitrogen gas supplied from a nitrogen gas supply unit 57 by a heat exchanger 58. The cooling gas is cooled to have a temperature lower than the freezing point of DIW. By discharging the cooling gas toward the liquid film formed on the substrate surface Wf, a freezing process is performed in which the liquid film is frozen to form a frozen film. Further, the DIW of a high temperature (hereinafter, referred to as “high-temperature DIW”) produced by heating the DIW of a normal temperature supplied from the DIW supply unit 91 by a heater 93 is supplied to the high-temperature DIW discharge nozzle 52 via a pipe 521. The high-temperature DIW discharge nozzle 52 discharges the high-temperature DIW toward the frozen film formed on the substrate surface Wf to perform a thawing process of thawing the frozen film.

The cooling gas discharge nozzle 51 and the high-temperature DIW discharge nozzle 52 are integrally movable substantially in the horizontal direction. Specifically, the cooling gas discharge nozzle 51 is attached to a tip part of an arm 53 extending substantially in the horizontal direction, and a base end part of the arm 53 is connected to a rotary shaft 55 extending substantially in the vertical direction. Further, the high-temperature DIW discharge nozzle 52 is attached to a tip part of an arm 54 extending substantially in parallel to the arm 53, and a base end part of the arm 54 is connected to the rotary shaft 55 similarly to the arm 53. An arm rotating mechanism 56 rotates the rotary shaft 55 about a center of rotation A2, whereby the cooling gas discharge nozzle 51 and the high-temperature DIW discharge nozzle 52 are integrally movable between a facing position P21 facing the substrate W and a retracted position P22 above and laterally retracted from the upper surface of the substrate W as shown in FIG. 2. Note that the cooling gas discharge nozzle 51 and the high-temperature DIW discharge nozzle 52 can be positioned at any arbitrary position facing the substrate W and the facing position P21 shown in FIG. 2 is an example thereof.

During the freezing process, the cooling gas discharge nozzle 51 discharges the cooling gas downward while moving between a position above the vicinity of the center of the substrate W and a position above the peripheral edge part of the substrate W after the liquid film is formed, whereby the liquid film is frozen. Thereafter, the high-temperature DIW discharge nozzle 52 discharges the high-temperature DIW downward in a state positioned substantially above the center of the substrate W, whereby the thawing process is performed. By supplying the high-temperature DIW to the frozen film formed by freezing the liquid film on the substrate in this way, the frozen film is thawed in a short time. Further, by integrally moving the cooling gas discharge nozzle 51 and the high-temperature DIW discharge nozzle 52, a processing time from the freezing of the liquid film to the thawing can be shortened.

A discharge flow rate of the cooling gas from the cooling gas discharge nozzle 51 is changeable. During the freezing process, the discharge flow rate is set at a relatively high flow rate (hereinafter, referred to as a “freezing flow rate”) to freeze the liquid film formed on the substrate surface Wf by supplying a large quantity of the cooling gas to the liquid film. On the other hand, if the discharge flow rate of the cooling gas is set at a flow rate lower than the freezing flow rate (hereinafter, referred to as a “slow leak flow rate”), a slow leak process is performed in which the cooling gas is discharged at a low flow rate from the cooling gas discharge nozzle 51. By performing the slow leak process before the freezing process, a temperature rise caused by the retention of the cooling gas in the pipe 511 leading to the cooling gas discharge nozzle 51 from the heat exchanger 58 and in the cooling gas discharge nozzle 51 is suppressed. As a result, the cooling gas of a sufficiently low temperature can be supplied to the liquid film from an initial stage of the freezing process, whereby the liquid film can be quickly frozen.

Here, the cooling gas discharged from the cooling gas discharge nozzle 51 during the slow leak process may partly freeze the processing liquids such as the chemical and the rinsing liquid present on the substrate surface Wf. In this case, frozen fragments of the processing liquids may damage a pattern formed on the substrate surface Wf. Further, water vapor in the atmosphere may be condensed and adhere to the substrate W due to the cooling gas released into the processing space SP. Thus, the cooling gas discharged from the cooling gas discharge nozzle 51 in the slow leak process needs to be collected. To this end, a receiving member 59 for receiving the cooling gas discharged in the slow leak process is provided below the cooling gas discharge nozzle 51 positioned at the retracted position P22. The receiving member 59 is in the form of a recess open upward and the cooling gas flowing into the receiving member 59 through the opening is collected by the gas/liquid collecting unit 45 connected to the receiving member 59 via a pipe 591.

Note that the receiving member 59 is arranged at such a position as to be able to also receive the high-temperature DIW discharged from the high-temperature DIW discharge nozzle 52 positioned at the retracted position P22. Specifically, the opening in the upper part of the receiving member 59 is located at a position right below the high-temperature DIW discharge nozzle 52 positioned at the retracted position P22. By performing pre-dispensing to discharge the high-temperature DIW from the high-temperature DIW discharge nozzle 52 located at the retracted position P22 as described later, the discharged high-temperature DIW flows into the receiving member 59 and is collected into the gas/liquid collecting unit 45 via the same pipe 591 as the cooling gas is collected. The pre-dispensing is a process for discharging the high-temperature DIW of a reduced temperature retained in the pipe 521 leading to the high-temperature DIW discharge nozzle 52 from the heater 93 and in the high-temperature DIW discharge nozzle 52 in advance. The pre-dispensing is performed to quickly thaw the frozen film by supplying the DIW of a sufficiently high temperature to the frozen film from an initial stage of the thawing process.

Further, the splash guard 60 for receiving the liquid supplied to and falling from the substrate W is provided to surround the lateral periphery of the spin chuck 20 in the substrate processing apparatus 1. More specifically, the splash guard 60 includes the port 61 provided to surround the spin base 21 and configured to receive liquid droplets spun off from the substrate W, a cup 62 configured to receive the liquid flowing down along the inner side surface of the port 61 and an exhaust ring 63 configured to house the port 61 and the cup 62 inside. The spin chuck 20 is arranged in an internal space surrounding by each of these members.

A side wall 611 of the port 61 is formed into a hollow cylindrical shape substantially coaxial with the center of rotation A0 of the substrate and the upper surface portion 612 is formed into a brim protruding inward. In other words, the upper surface portion 612 extends slightly upward toward a center from an upper end part of the side wall 611, and an opening 613 having an opening diameter slightly larger than a diameter of the spin base 21 and substantially coaxial with the center of rotation A0 is provided in a central part. The port 61 is movable upward and downward by a port elevating mechanism 64, and an opening plane of the opening 613 is slightly lower than the upper surface of the spin base 21 at an lower position shown by solid line in FIG. 1, whereby the side surface of the substrate W is exposed in the processing space SP. On the other hand, at an upper position shown by dotting line in FIG. 1, the opening plane of the opening 613 is located above the upper surface of the substrate W held on the spin base 21, whereby the side surface of the substrate W is surrounded by the side wall 611 of the port 61. When various processing liquids are supplied to the substrate W, the port 61 is positioned at the upper position to receive the liquid spun off from the peripheral edge part of the substrate W. The liquid flowing down along the inner wall surface of the port 61 falls into the cup 62 provided below the side wall 611 of the port 61 and having an open upper part and is collected into a waste liquid collecting unit 65 from the cup 62.

Since the vapor of the chemical of a high concentration is filled in an internal space formed by the port 61 and the cup 62, the exhaust ring 63 is provided to exhaust this. The exhaust ring 63 is arranged to surround the port 61 and the cup 62, and an exhaust pipe 12 extending to the outside of the processing chamber 10 communicates with a lower part of the exhaust ring 63. The exhaust pipe 12 is connected to an exhaust pump 13 and the gas in the exhaust ring 63 is exhausted by the exhaust pump 13. Thus, the clean atmosphere in the processing space SP is taken in through the opening 613 in the upper part of the port 61, thereby generating an air flow flowing out to the outside via the exhaust ring 63 through a clearance between the port 61 and the cup 62. This suppresses the outflow of the vapor of the chemical, mist and the like generated in the internal space of the splash guard 60 into the processing space SP.

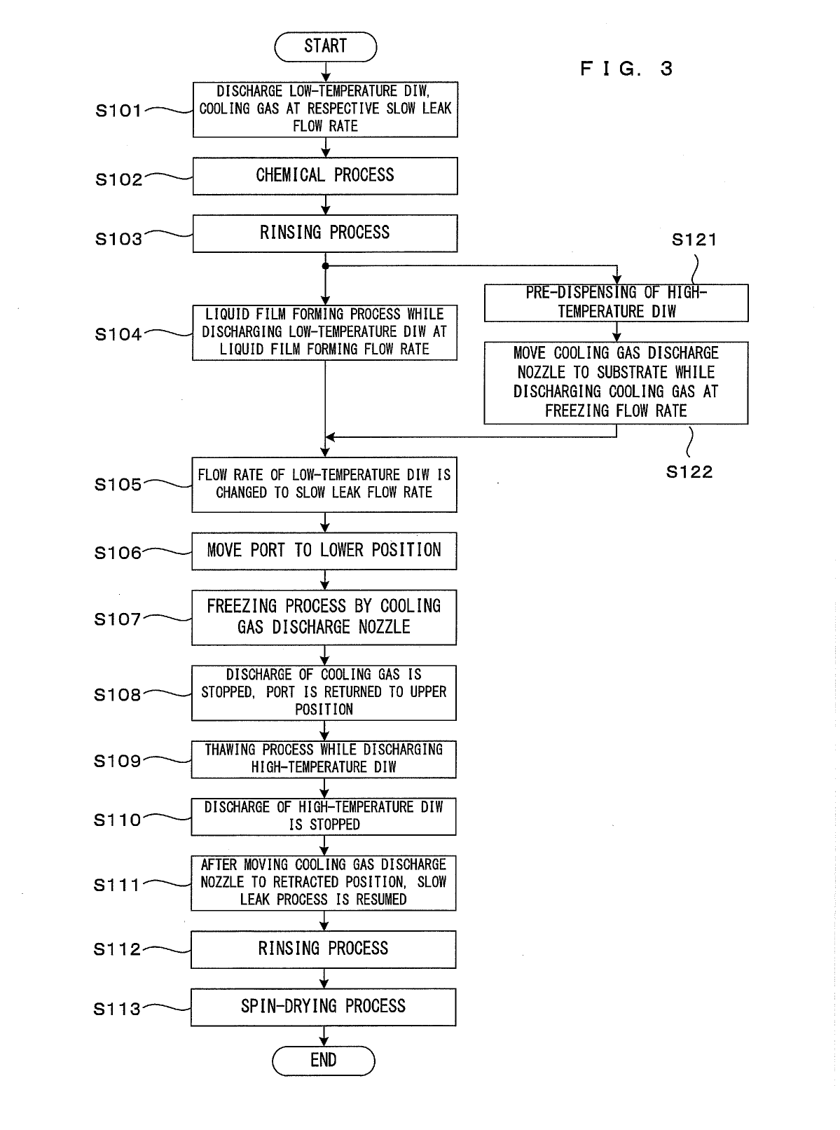

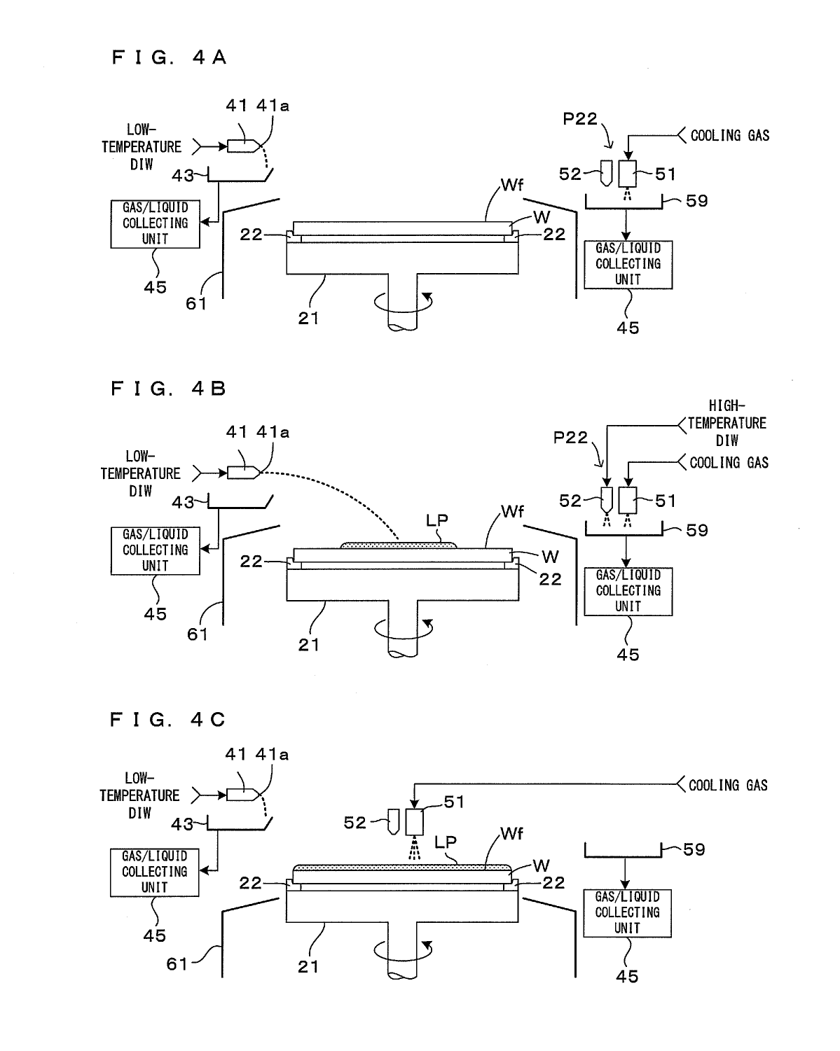

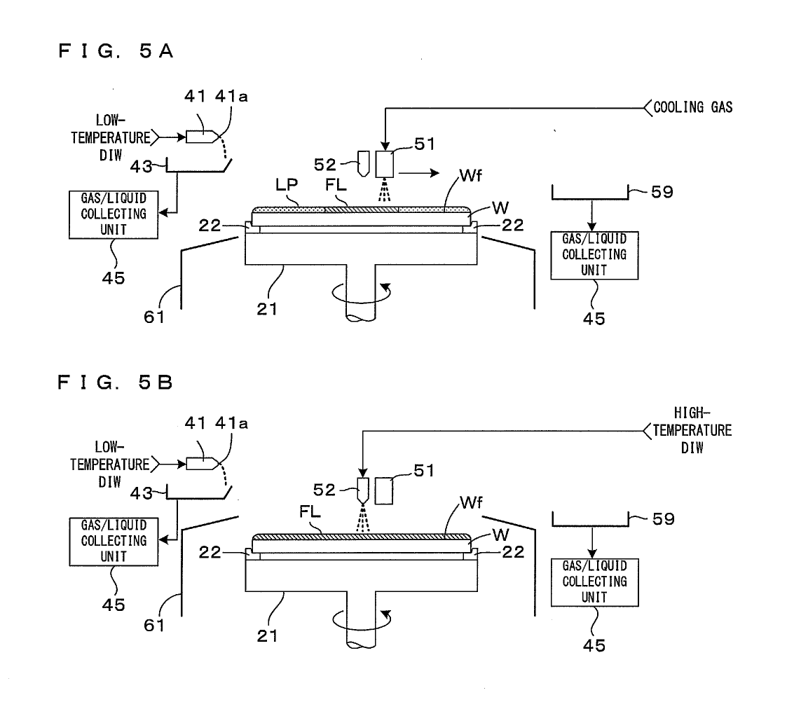

The flow of the substrate cleaning process performed using the substrate processing apparatus 1 configured as described above is described. FIG. 3 is a flow chart showing an example of the substrate cleaning process. FIGS. 4A to 4C, 5A and 5B are views diagrammatically showing the operation of each component in the substrate cleaning process. In the substrate processing apparatus 1, an unprocessed substrate W carried into the processing chamber 10 is held by the spin chuck 20 with a surface Wf thereof faced up and the cleaning process is performed. Further, during the cleaning process, the chuck rotating mechanism 23 appropriately rotates the substrate W together with the spin base 21 at a predetermined rotation speed corresponding to each process. The port 61 of the splash guard 60 is positioned at the upper position.

When the cleaning process is started, the low-temperature DIW slow leak process of discharging the low-temperature DIW at the slow leak flow rate (e.g. 0.1 L/min) from the discharge port 41a of the low-temperature DIW discharge nozzle 41 and the cooling gas slow leak process of discharging the cooling gas at the slow leak flow rate (e.g. 10 L/min) from the cooling gas discharge nozzle 51 at the retracted position P22 are first started (Step S101, FIG. 4A). During the execution of the low-temperature DIW slow leak process, the low-temperature DIW discharged at a relatively low flow rate from the discharge port 41a of the low-temperature DIW discharge nozzle 41 is received by the receiving member 43 without reaching the substrate W and finally collected by the gas/liquid collecting unit 45. Similarly, during the execution of the cooling gas slow leak process, the cooling gas discharged from the cooling gas discharge nozzle 51 flows into the receiving member 59 and is collected by the gas/liquid collecting unit 45.

With the low-temperature DIW and the cooling gas kept discharged at the corresponding slow leak flow rates, the chemical process and the rinsing process are subsequently performed in a state where the substrate W is rotated, for example, at 800 rpm by the chuck rotating mechanism 23 (Steps S102, S103). First, the chemical discharge nozzle 31 positioned substantially above the center of the substrate W by the arm rotating mechanism 37 discharges the chemical toward the substrate surface Wf to perform the chemical process. When the chemical process is finished, the rinsing liquid discharge nozzle 32 positioned substantially above the center of the substrate W by the arm rotating mechanism 37 discharges the rinsing liquid toward the substrate surface Wf to perform the rinsing process.

When the rinsing process is finished, the rotation speed of the substrate W is reduced, for example, to 150 rpm by the chuck rotating mechanism 23 and the discharge flow rate of the low-temperature DIW from the discharge port 41a of the low-temperature DIW discharge nozzle 41 is increased from the slow leak flow rate to the liquid film forming flow rate (e.g. 1.5 L/min) to perform the liquid film forming process (Step S104, FIG. 4B). By increasing the discharge flow rate of the low-temperature DIW to the liquid film forming flow rate, the low-temperature DIW discharged from the discharge port 41a of the low-temperature DIW discharge nozzle 41 reaches a central part of the substrate surface Wf and the low-temperature DIW supplied to the substrate surface Wf forms a liquid film LP.

Then, the low-temperature DIW supplied to the substrate surface Wf spreads from the central part to a peripheral part of the substrate W by a centrifugal force to enlarge a formation range of the liquid film LP made of the low-temperature DIW. At this time, since the rotation speed of the substrate W is reduced, it is suppressed that the low-temperature DIW supplied to the substrate surface Wf is spun off from the substrate surface Wf by an excessive centrifugal force, and the liquid film LP can be efficiently formed. When the liquid film LP is formed on the entire substrate surface Wf and the liquid film forming process is completed, the discharge flow rate of the low-temperature DIW is returned to the slow leak flow rate and the slow leak process is resumed (Step S105). By performing the low-temperature DIW slow leak process except during the execution of the liquid film forming process in this way, it is suppressed that the low-temperature DIW is retained and warmed in the pipe 411 leading to the low-temperature DIW discharge nozzle 41 and in the low-temperature DIW discharge nozzle 41. As a result, the DIW of a sufficiently low temperature whose temperature rise is suppressed is supplied from the initial stage of the liquid film forming process.

Before the liquid film forming process is finished, the pre-dispensing of discharging a predetermined amount of the high-temperature DIW by the high-temperature DIW discharge nozzle 52 at the retracted position P22 is performed (Step S121, FIG. 4B). This pre-dispensing is a process of discharging the high-temperature DIW retained in the pipe 521 leading to the high-temperature DIW discharge nozzle 52 from the heater 93 and cooled by the ambient atmosphere from the pipe 521. By performing the pre-dispensing, the DIW of a sufficiently high temperature is discharged from the high-temperature DIW discharge nozzle 52 from the beginning in the thawing process performed later. A discharge amount of the DIW during the pre-dispensing is not less than the internal volume of the pipe 521 downstream of the heater 93 and the high-temperature DIW discharge nozzle 52. Note that the high-temperature DIW discharged from the high-temperature DIW discharge nozzle 52 by the pre-dispensing is received by the receiving member 59 and finally collected by the gas/liquid collecting unit 45.

After the pre-dispensing, the arm rotating mechanism 56 moves the cooling gas discharge nozzle 51 from the retracted position P22 toward a position above the vicinity of the center of the substrate W (Step S122). By moving the cooling gas discharge nozzle 51 in parallel with the liquid film formation, the cooling gas can be immediately discharged toward the liquid film LP from the cooling gas discharge nozzle 51 after the liquid film LP is formed on the entire substrate surface Wf. This can suppress a temperature rise of the liquid film LP and shortens a processing time.

Note that the discharge flow rate of the cooling gas is increased from the slow leak flow rate to the freezing flow rate (e.g. 90 L/min) in starting the movement of the cooling gas discharge nozzle 51 in Step S122. By doing so, the cooling gas can be supplied at the freezing flow rate to the liquid film LP and the liquid film LP can be cooled also in the process of moving the cooling gas discharge nozzle 51 from the retracted position P22 toward the position above the vicinity of the center of the substrate W. Further, since the cooling gas slow leak process is performed until the cooling gas discharge nozzle 51 starts moving, the cooling gas discharged at the freezing flow rate can have a sufficient low temperature from the beginning.

When the liquid film forming process is finished, i.e. when the discharge flow rate from the low-temperature DIW discharge nozzle 41 is returned from the liquid film forming flow rate to the slow leak flow rate (Step S105), after the cooling gas discharge nozzle 51 reaches the vicinity of the center of the substrate W, the rotation speed of the substrate W is reduced, for example, to 50 rpm by the chuck rotating mechanism 23. The port 61 is moved to the lower position to expose the substrate W (Step S106, FIG. 4C). With the substrate W rotated at this rotation speed, the arm rotating mechanism 56 moves the cooling gas discharge nozzle 51 from the position above the vicinity of the center of the substrate W toward a position above the peripheral edge part of the substrate W along the upper surface of the substrate W. During that time, the cooling gas discharge nozzle 51 discharges the cooling gas at the freezing flow rate toward the liquid film LP on the substrate surface Wf. In this way, the freezing process of freezing the liquid film LP to form a frozen film FL is performed (Step S107, FIG. 5A). The liquid film LP is successively frozen from the center toward the peripheral edge part of the substrate as the cooling gas discharge nozzle 51 is moved. Finally, the frozen film FL is formed on the entire substrate surface Wf. When the cooling gas discharge nozzle 51 reaches the substrate peripheral edge part, the discharge of the cooling gas is stopped (Step S108) and the port 61 of the splash guard 60 is returned to the upper position.

Subsequently, the arm rotating mechanism 56 positions the high-temperature DIW discharge nozzle 52 at a position substantially above the center of the substrate W and the high-temperature DIW discharge nozzle 52 discharges the high-temperature DIW toward the frozen film FL on the substrate surface Wf. In this way, the thawing process of thawing the frozen film by the high-temperature DIW is performed (Step S109, FIG. 5B). Note that, in the thawing process, the thawed frozen film can be removed together with extraneous matters from the substrate surface Wf by a large centrifugal force by increasing the rotation speed of the substrate W, for example, to 2000 rpm by the chuck rotating mechanism 23. Since the pre-dispensing is performed at the retracted position P22 in advance, the high-temperature DIW discharge nozzle 52 can discharge the DIW of a high temperature from the beginning. When the thawing process is finished, the discharge of the high-temperature DIW from the high-temperature DIW discharge nozzle 52 is stopped (Step S110). After the arm rotating mechanism 56 retracts the cooling gas discharge nozzle 51 to the retracted position P22, the cooling gas slow leak process is resumed (Step S111).

Thereafter, the arm rotating mechanism 37 moves the rinsing liquid discharge nozzle 32 from the retracted position P12 to the facing position P11. Then, the rinsing liquid discharge nozzle 32 positioned substantially above the center of the substrate W discharges the rinsing liquid toward the substrate surface Wf to perform the rinsing process (Step S112). Finally, after the supply of the rinsing liquid to the substrate W is stopped and the rinsing liquid discharge nozzle 32 is retracted to the retracted position P12, the chuck rotating mechanism 23 increases the rotation speed of the substrate W, for example, to 2500 rpm to perform a spin-drying process (Step S113), whereby a series of cleaning processes are finished.

Next, an atmosphere control in the substrate cleaning process described above is described. The substrate process in this embodiment is performed in a state where the substrate W to be processed is placed in the processing chamber 10 in which a down flow is formed and the substrate W is surrounded by the splash guard 60. Such a processing mode is a general technique conventionally used in a wet process. However, the inventors of this application found out that the following atmosphere control was effective in the process including the freezing of the liquid film by supplying the cooling gas to the liquid film on the substrate W as in this embodiment. Specifically, to efficiently freeze the liquid film in a short time and satisfactorily remove particles, it is effective to dynamically control the atmosphere in the processing space SP in the chamber, particularly above the substrate.

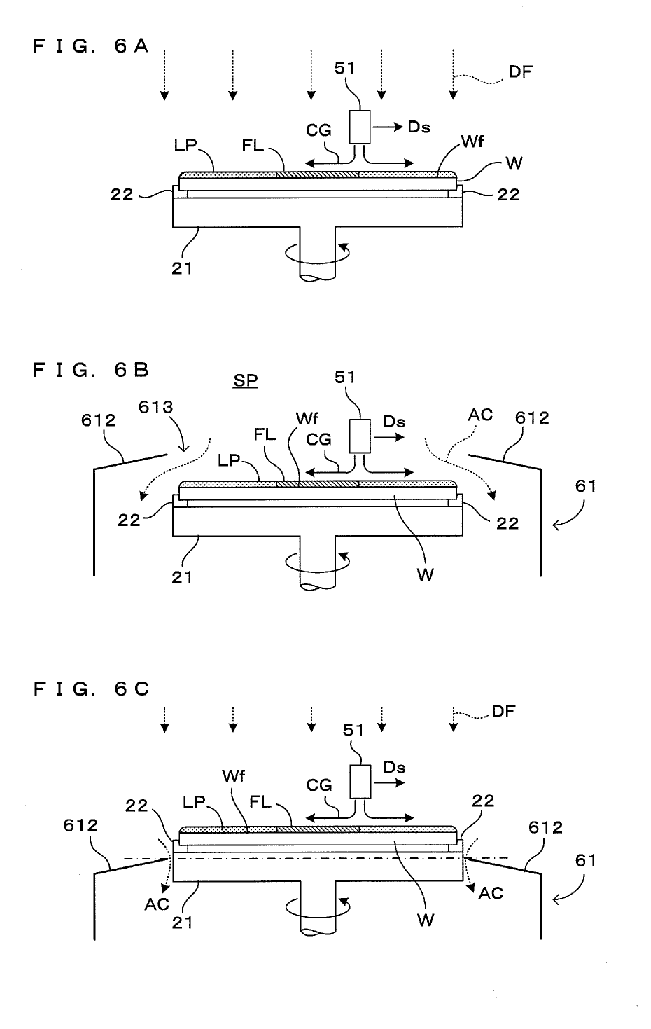

FIGS. 6A to 6C are views diagrammatically showing the atmosphere control in this embodiment. As shown in FIG. 6A, the cooling gas discharge nozzle 51 is arranged to face the surface Wf of the substrate W in the freezing process step (Step S107 in FIG. 3) of this embodiment. Then, the cooling gas discharge nozzle 51 is scanned and moved in a scanning direction Ds (e.g. reciprocating direction along a substrate radius) along the substrate surface Wf while discharging cooling gas CG cooled to a temperature lower than the freezing point of the DIW forming the liquid film LP. In this way, the liquid film LP formed on the substrate W is successively frozen to form the frozen film FL.

At this time, the cooling gas CG supplied to the substrate W spreads around along the substrate surface Wf after freezing the liquid film LP on the substrate W at a position right below the nozzle. By covering the substrate surface Wf by the cooling gas CG in this way, a low-temperature state of the unfrozen liquid film LP is maintained and a temperature rise of the frozen film FL already frozen is suppressed. In this way, the frozen film FL can be formed on the entire surface of the substrate W in a short time.

However, a down flow DF formed by the FFU 11 flows downward from a side above the substrate W as indicated by dotted line in FIG. 6A. This down flow DF is a flow of normal-temperature gas. The down flow DF pushes out the cooling gas CG on the substrate W or is mixed with the cooling gas CG, whereby the temperature of the liquid film LP or the frozen film FL may increase on the substrate surface Wf. This causes a longer time necessary to freeze the entire liquid film LP.

This may also cause a reduction in removal rate for particles and the like. As already disclosed, for example, in JP2011-198894A by the applicant of this application, a particle removal rate is known to be improved not only by merely cooling and freezing the liquid film, but also by reducing a reaching temperature of the frozen film after freezing in the freeze cleaning technology. However, there is a possibility that the temperature of the frozen film FL is not sufficiently reduced and a high particle removal rate cannot be obtained due to the down flow DF toward the substrate surface Wf.

Further, a problem similar to the one caused by the down flow from the FFU 11 is caused also by the splash guard 60 surrounding the substrate W. A case is considered where the freezing process step is performed in a state where the port 61 of the splash guard 60 is located at the upper position (dotted-line position in FIG. 1) to receive the liquid spun off from the peripheral edge part of the substrate W as shown in FIG. 6B. Since the internal space surrounded by the port 61 is exhausted by the exhaust pump 13 (FIG. 1), the atmosphere in the processing chamber 10 (i.e. processing space SP) is taken in through the opening 613 in the upper part of the port 61. At this time, an air current AC flowing into the port 61 through a clearance between the port upper surface portion 612 and the substrate W from the opening 613 is formed. This air current AC causes the scattering of the cooling gas CG on the substrate W similarly to the down flow DF in the case of FIG. 6A, thereby causing problems that it takes time to freeze the liquid film and the temperature of the frozen film is not sufficiently reduced.

Accordingly, in performing the freezing process in this embodiment, the following measures are taken as shown in FIG. 6C.

(1) The port 61 is lowered to the lower position, i.e. position where the position of an opening plane of the port 61 shown by dashed-dotted line in FIG. 6C is slightly lower than the upper surface of the spin base 21.

(2) A flow rate of the down flow DF generated by the FFU 11 is lower than the one during the preceding and succeeding processes, i.e. the wet process and the liquid film forming process before the freezing process, and the rinsing process and a spin drying process after the freezing process.

The down flow DF shown by short arrows in FIG. 6C indicates a lower flow velocity of the down flow than the one shown by long arrows in FIG. 6A.

The port 61 is lowered to the lower position, the opening 613 of the port 61 is mostly closed by the spin base 21 and an effective opening area is drastically reduced. This causes the air current AC generated as the port internal space is exhausted passes only through a clearance between the port upper surface portion 612 and the spin base 21, thereby drastically limiting a flow rate of the air current AC. Further, since the substrate W is located above the opening 613, the air current AC is generated at a position distant from the substrate W and the influence thereof on the cooling gas CG on the substrate W is suppressed. In this way, the problems that it takes time to freeze the liquid film LP and the temperature of the frozen film FL is not sufficiently reduced and other problems caused by the air current generated by the exhaust of the air in the port 61 are avoided.

Note that it is sufficient to avoid the passage of the air current AC near the substrate W merely to prevent the scattering of the cooling gas CG on the substrate W by the air current AC. Accordingly, the opening plane of the port 61 has only to be at least lower than the surface Wf of the substrate W. Further, if the opening plane is lowered to a position below the upper surface of the spin base 21 as described above, it is more effective since the flow rate of the air current AC itself can be limited.

The lower the flow rate of the down flow by the FFU 11 during the freezing process, the larger the effect of avoiding the above problems. Further, since the liquid is not supplied to the substrate W and the substrate W is covered by the low-temperature DIW during the supply of the cooling gas, a possibility of the contamination of the substrate W by mist and the like is low. Based on this, the down flow may be completely stopped. On the other hand, a down flow having a low flow rate may be left to more reliably prevent the mist and the like from rising into the processing space SP during the freezing process.

To suppress an influence on the cooling gas CG supplied onto the substrate W, a flow velocity of the down flow DF in the freezing process is desirably lower than that of the cooling gas CG discharged toward the substrate W from the cooling gas discharge nozzle 51. In this embodiment, a discharge amount of the cooling gas CG from the cooling gas discharge nozzle 51 is 90 L/min and the flow velocity of the cooling gas immediately after the discharge is about 1 m/sec. Thus, the flow velocity of the down flow DF in the freezing process can be set at a flow velocity sufficiently lower than this, e.g. at about 0.2 m/sec. The flow velocity of the down flow DF in each process step other than the freezing process needs not be set in association with the flow velocity of the cooling gas and may be appropriately set according to a purpose. For example, in executing the liquid film forming process (Step S104) and the thawing process (Step S109), the flow velocity of the down flow DF may be set at a flow velocity (e.g. arbitrary value in a range from 0.2 msec to 1.5 m/sec) higher than 0.2 msec as the flow velocity of the down flow DF during the freezing process. The flow rate and flow velocity of the down flow DF are adjusted by the FFU control unit 14 (FIG. 1) controlling the FFU 11.

After the supply of the cooling gas to the liquid film is finished, the port 61 is returned to the upper position and the flow rate of the down flow DF is returned to the initial relatively high flow rate before the subsequent thawing process is performed. This causes the liquid component spun off from the substrate W in the subsequent thawing process, rinsing process and spin-drying process to be collected by the splash guard 60, thereby preventing the scattering in the processing chamber 10. This can also prevent the mist from rising into the processing space SP and the high-humidity atmosphere in the splash guard 60 from flowing out to the processing space SP.

Note that the measures (1) and (2) described above respectively have independent effects and can be taken independently of each other. Specifically, an effect of reducing the scattering of the cooling gas CG on the substrate W is obtained only by taking either one of the measures. Of course, a larger effect can be obtained by taking the both measures. Further, if the influence of either one of the down flow DF from the upper side and the air current AC caused by the exhaust is minor, a measure may be taken only for the other.

Further, if it is possible to change an exhaust ability by the exhaust pump 13, an exhaust amount during the freezing process may be reduced instead of or in addition to the above measure (1). This can suppress the air current AC generated near the substrate W due to the exhaust and suppress the scattering of the cooling gas CG. Besides, the exhaust amount can be changed by various methods such as by providing a valve in the exhaust pipe 12 and adjusting an opening thereof and by switching a plurality of exhaust systems from one to another. Further, the exhaust may also be completely stopped.

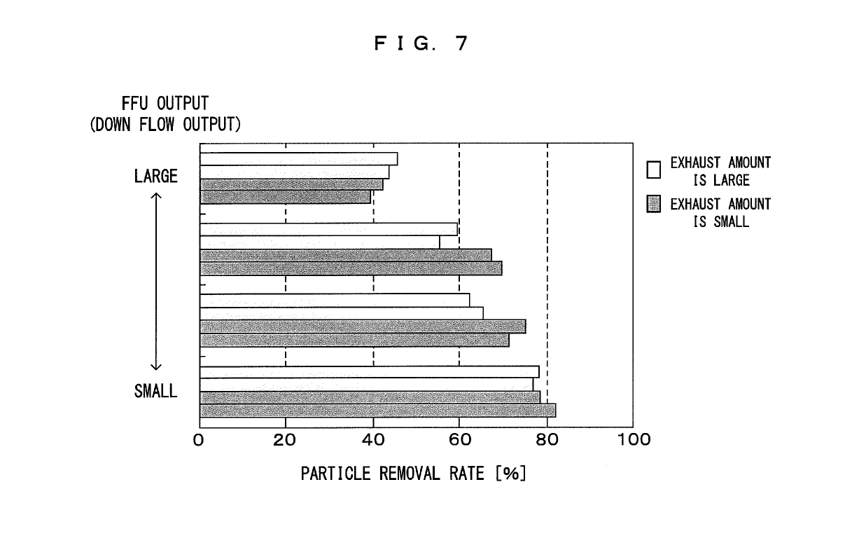

FIG. 7 is a graph showing an example of an experimental result of measurement of the particle removal rate by changing the intensity of the down flow near the substrate surface. In this experiment, a down flow output from the FFU 11 was changed in four steps, the exhaust ability by the exhaust pump 13 was changed in two steps and the particle removal rate was measured by variously changing the combination of these in a state where the port 61 was fixed at the upper position. In FIG. 7, two measurement results are shown for each combination.

As shown in FIG. 7, the particle removal rate is improved with a reduction in the output of the FFU 11 and the flow rate of the down flow. Further, at the same FFU output, a higher particle removal rate is obtained when the exhaust amount is small, i.e. the exhaust ability of the exhaust pump is low. Note that, on the condition that the FFU output is maximum, the particle removal rate is not improved even if the exhaust ability of the exhaust pump 13 is reduced. The reason for that is thought to be as follows. The flow velocity of the down flow by the FFU 11 at this time was substantially the same as the flow velocity of the cooling gas discharged from the cooling gas discharge nozzle 51. Thus, a reduction in the particle removal rate at this time is thought to be largely affected by the scattering of the cooling gas caused by the down flow from the FFU 11 and not reflecting the effect of reducing the exhaust ability of the exhaust pump 13. It is found that the particle removal rate is largely improved by making the flow velocity of the down flow lower than that of the cooling gas and further improved by reducing the exhaust ability.

As described above, in this embodiment, the spin chuck 20 functions as a “substrate holder” of the invention, and the spin base 21 corresponds to an “opening area restricting member” of the invention. Further, the low-temperature DIW discharge nozzle 41 and the high-temperature DIW discharge nozzle 52 respectively function as a “liquid film former” and a “remover”, whereas the FFU 11 functions as an “air flow generator” of the invention. Further, in this embodiment, the high-temperature DIW corresponds to a “thawing liquid” of the invention.

Further, in the above embodiment, the port 61 of the splash guard 60 functions as a “collector” of the invention and the port elevating mechanism 64 functions as an “elevating mechanism” of the invention. Further, the exhaust pump 13 and the exhaust pipe 12 integrally function as a “drainer” of the invention. Further, the processing space SP surrounded by the processing chamber 10 corresponds to a “closed space” of the invention.

As described above, the substrate processing apparatus of this embodiment performs the cleaning process for the substrate W by forming the liquid film LP on the surface Wf of the substrate W held substantially in the horizontal posture in the processing space SP, freezing the liquid film and removing the frozen film FL. The liquid film LP is frozen by supplying the cooling gas CG cooled to the temperature lower than the freezing point of the liquid (DIW) forming the liquid film to the liquid film. The flow rate of the down flow in the processing space SP is reduced when the cooling gas is supplied to the liquid film than when the liquid film LP is formed on the substrate W. By doing so, it can be suppressed that the cooling gas CG supplied onto the substrate W is scattered from the substrate W by the down flow and the normal-temperature gas is mixed with the cooling gas to increase the gas temperature.

Accordingly, in this embodiment, the liquid film on the substrate W can be efficiently frozen in a short time and a high particle removal rate can be obtained by reducing the reaching temperature of the frozen film. Further, in performing the liquid film forming process of forming the liquid film on the substrate W, the down flow having a flow rate higher than that during the freezing process is formed. Thus, the clean atmosphere can be maintained around the substrate W and the adhesion of the rising mist and the like to the substrate can be prevented.

Since the cooling gas discharge nozzle 51 is scanned and moved relative to the liquid film LP on the substrate W in this embodiment, the cooling gas discharged from this nozzle is locally supplied to the liquid film LP. Thus, if the cooling gas scatters without staying on the substrate W at positions other than the position facing the cooling gas discharge nozzle 51, the liquid film LP or the frozen film FL on the substrate W cannot be maintained at a low temperature. By weakening the down flow in scanning and moving the cooling gas discharge nozzle 51 as in this embodiment, the liquid film LP and the frozen film FL on the substrate W can be maintained at a low temperature.

Further, in this embodiment, the substrate W is held in the processing space SP in the processing chamber 10 and the down flow is generated by blowing the clean gas in the processing space SP downward from the FFU 11 arranged at the top of the processing chamber 10. By doing so, the mist and the like generated in the processing chamber 10 can be pushed out to below the substrate W, thereby preventing adhesion to the substrate W. On the other hand, because the down flow scatters the cooling gas in the freezing process, it is effective to make this down flow weaker during the freezing process than during the liquid film forming process.

Further, in supplying the high-temperature DIW as the thawing liquid to the frozen film, the flow rate of the down flow is preferably set relatively high to prevent the thawing liquid and the melted liquid of the frozen film from scattering and re-adhering to the substrate W. Specifically, a down flow having a flow rate higher than that in the freezing process is preferably formed in the thawing process.

Further, in this embodiment, the splash guard 60 laterally surrounding the substrate W and configured to receive the scattering liquid is provided and the internal space where the substrate W is held is exhausted by the exhaust pump 13. This can prevent the outflow of the vapor of the chemical or the high-humidity atmosphere generated in the internal space to the processing space SP. The air current generated around the substrate W due to the exhaust may cause the scattering of the cooling gas similarly to the down flow described above. Based on this, the exhaust amount by the exhaust pump 13 is reduced in the freezing process step of this embodiment than in the other steps. By doing so, the scattering of the cooling gas can be suppressed by weakening the air current generated due to the exhaust and the liquid film LP and the frozen film FL on the substrate W can be maintained at a low temperature.

Specifically, during the execution of the freezing process, the port 61 of the splash guard 60 laterally covering the substrate W is lowered to move the opening 613 to a position below the substrate W, thereby exposing the substrate W in the processing space SP. This can prevent the passage of the air current near the substrate W. Further, the opening area of the port 61 is restricted by the spin base 21, whereby the exhaust amount can be suppressed more.

Note that the invention is not limited to the above embodiment and various changes other than the aforementioned ones can be made without departing from the gist thereof. For example, although the substrate processing apparatus is provided with the splash guard 60 for receiving the liquid falling down from the substrate W in the above embodiment, the down flow control technology described above can be suitably applied also to apparatuses not provided with such a configuration.

For example, in the above embodiment, the low-temperature DIW discharge nozzle 41 for supplying the low-temperature DIW to the substrate W to form the liquid film LP is provided at the position above and laterally retracted from the substrate W. However, a low-temperature DIW discharge nozzle may be, for example, provided on a pivotable arm similarly to the cooling gas discharge nozzle 51 and the like and may is moved to a position facing the substrate W to supply the low-temperature DIW.

Further, in the above embodiment, the entire liquid film is finally frozen by scanning and moving the cooling gas discharge nozzle 51 for locally discharging the cooling gas to the liquid film on the rotating substrate W. However, a supply mode of the cooling gas is not limited to this. For example, a cooling gas discharge nozzle positioned above the vicinity of the center of rotation of the substrate W may radially discharge the cooling gas to the liquid film on the substrate W. Further, a cooling gas discharge nozzle with a slit-like opening may discharge the cooling gas from the center to the peripheral edge part of the substrate W. The atmosphere control according to the invention effectively functions also in these configurations.

Further, the substrate processing apparatus 1 of the above embodiment is an integrated processing apparatus for continuously performing the processes from the wet process using the chemical to the drying process after cleaning in the processing chamber 10. However, an object of application of the invention is not limited to this. The invention can be applied to substrate processing apparatuses in general at least provided with a configuration for forming a liquid film on a substrate W, freezing the liquid film and thawing and removing a frozen film.

This invention is applicable to substrate processing apparatuses and substrate processing methods in general for processing a substrate by forming a liquid film on the substrate, freezing the liquid film and removing the frozen film. Substrates to be processed include semiconductor wafers, glass substrates for photo mask, glass substrates for liquid crystal display, glass substrates for plasma display, substrates for FED, substrates for optical disc, substrates for magnetic disc, substrates for opto-magnetic disc and various other substrates.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A substrate processing apparatus, comprising:
a substrate holder which holds a substrate in a horizontal posture;
an air flow generator which generates a down flow by gas flowing from top to bottom around the substrate held by the substrate holder;
a liquid film former which forms a liquid film by supplying a liquid on an upper surface of the substrate held by the substrate holder;
a cooling gas discharge nozzle which discharges cooling gas of a temperature lower than a freezing point of the liquid forming the liquid film to the liquid film and thereby freezes the liquid film; and
a remover which removes a frozen film formed by freezing the liquid film from the substrate,
wherein the air flow generator reduces a flow velocity of the down flow when the cooling gas is discharged to the liquid film from the cooling gas discharge nozzle than when the liquid is supplied to the substrate from the liquid film former.

2. The substrate processing apparatus according to claim 1, wherein the cooling gas discharge nozzle is scanned and moved along the substrate upper surface while discharging the cooling gas.

3. The substrate processing apparatus according to claim 1, further comprising a processing chamber including a processing space capable of housing the substrate holder and the substrate, wherein the air flow generator generates the down flow by blowing gas downward from an upper area of the processing space.

4. The substrate processing apparatus according to claim 1, wherein:
the remover thaws and removes the frozen film by supplying a thawing liquid to the frozen film; and
the air flow generator increases the flow velocity of the down flow when the thawing liquid is supplied to the frozen film from the remover than when the cooling gas is discharged to the liquid film from the cooling gas discharge nozzle.

5. The substrate processing apparatus according to claim 1, further comprising:
a collector which includes a side wall for laterally surrounding the substrate held by the substrate holder and is configured such that the substrate is housed in an internal space enclosed by the side wall, an opening for exposing an upper part of the substrate is formed by an upper end part of the side wall and the liquid falling down from the substrate is collected; and
a drainer which drains a fluid in the internal space of the collector to outside,
wherein the drainer reduces a drain amount of the fluid from the internal space when the cooling gas is discharged to the liquid film from the cooling gas discharge nozzle than when the liquid is supplied to the substrate from the liquid film former.

6. The substrate processing apparatus according to claim 5, further comprising an elevating mechanism which relatively moves the collector upward and downward with respect to the substrate,
wherein the elevating mechanism positions an opening plane of the opening of the collector above the upper surface of the substrate when the liquid is supplied to the substrate from the liquid film former while positioning the opening plane below the upper surface of the substrate when the cooling gas is discharged to the liquid film from the cooling gas discharge nozzle.

7. A substrate processing apparatus, comprising:
a substrate holder which holds a substrate in a horizontal posture;
a liquid film former which forms a liquid film by supplying a liquid on an upper surface of the substrate held by the substrate holder;
a cooling gas discharge nozzle which discharges cooling gas of a temperature lower than a freezing point of the liquid forming the liquid film to the liquid film and thereby freezes the liquid film;
a remover which removes a frozen film formed by freezing the liquid film from the substrate;
a collector which includes a side wall for laterally surrounding the substrate held by the substrate holder and is configured such that the substrate is housed in an internal space enclosed by the side wall, an opening for exposing an upper part of the substrate is formed by an upper end part of the side wall and the liquid falling down from the substrate is collected; and
a drainer which drains a fluid in the internal space of the collector to outside,
wherein the drainer reduces a drain amount of the fluid from the internal space when the cooling gas is discharged to the liquid film from the cooling gas discharge nozzle than when the liquid is supplied to the substrate from the liquid film former.

8. The substrate processing apparatus according to claim 7, further comprising an elevating mechanism which relatively moves the collector upward and downward with respect to the substrate,
wherein the elevating mechanism positions an opening plane of the opening of the collector above the upper surface of the substrate when the liquid is supplied to the substrate from the liquid film former while positioning the opening plane below the upper surface of the substrate when the cooling gas is discharged to the liquid film from the cooling gas discharge nozzle.

9. The substrate processing apparatus according to claim 8, wherein the substrate holder includes an opening area restricting member which restricts an opening area of the opening when the opening plane is positioned below the upper surface of the substrate by the elevating mechanism.

10. A substrate processing method, comprising:
a substrate holding step of holding a substrate in a horizontal posture;
an air flow generating step of generating a down flow by gas flowing from top to bottom around the substrate;
a liquid film forming step of forming a liquid film by supplying a liquid on an upper surface of the substrate;
a freezing step of freezing the liquid film by supplying cooling gas of a temperature lower than a freezing point of the liquid forming the liquid film to the liquid film; and
a removing step of removing a frozen film formed by freezing the liquid film from the substrate,
wherein a flow velocity of the down flow in the freezing step is set lower than a flow velocity of the down flow in the liquid film forming step.

11. The substrate processing method according to claim 10, wherein the frozen film is thawed and removed by supplying a thawing liquid to the frozen film in the removing step and the flow velocity of the down flow in the removing step is set higher than that in the freezing step.

12. The substrate processing method according to claim 10, wherein:
the substrate is held in a closed space in the substrate holding step and the down flow is generated by allowing gas to flow into the closed space from outside or exhausting gas to the outside from the closed space in the air flow generating step; and
the flow velocity of the down flow is changed by changing the amount of the gas flowing into the closed space from the outside or the amount of the gas exhausted to the outside from the closed space.
